(19) United States
(12) Patent Application Publication
(10) Pub. No.: US 2018/0123896 A1
(43) Pub. Date: May 3, 2018

(54) SYSTEMS AND METHODS FOR HIERARCHICAL NETWORK MANAGEMENT

(71) Applicants: Xu LI, Nepean (CA); Nimal Gamini SENARATH, Ottawa (CA)

(72) Inventors: Xu LI, Nepean (CA); Nimal Gamini SENARATH, Ottawa (CA)

(73) Assignee: Huawei Technologies Co., Ltd., Shenzhen (CN)

(21) Appl. No.: 15/794,318

(22) Filed: Oct. 26, 2017

Related U.S. Application Data
(60) Provisional application No. 62/415,778, filed on Nov. 1, 2016.

(51) Int. Cl. H04L 12/24

(52) U.S. Cl. CPC H04L 41/12; H04L 47/82; H04L 41/20; H04L 41/046

(57) ABSTRACT

A method for managing a communications network includes providing a parent network manager in a parent domain of the communications network, and providing a child network manager in a child domain of the communications network. The parent network manager comprises at least one of a parent Service Oriented Network Auto Creation (SONAC) function and a parent MANagement and Orchestration (MANO) function. The child network manager comprises at least one of a child Service Oriented Network Auto Creation (SONAC) function and a child MANagement and Orchestration (MANO) function. The parent and child network managers cooperate to optimize management of the parent and child domains of the communications network.

### CROSS-REFERENCE TO RELATED APPLICATIONS

This application is based on, and claims benefit of, U.S. Provisional Application No. 62/415,778 filed Nov. 1, 2016, the entire content of which is hereby incorporated herein by reference.

### FIELD OF THE INVENTION

The present invention pertains to the field of communication networks, and in particular to systems and methods for Hierarchical Network Management.

### BACKGROUND

Network functions virtualization (NFV) is a network architecture concept that uses the technologies of IT virtualization to virtualize entire classes of network node functions into building blocks that may connect, or chain together, to create communication services. NFV relies upon, but differs from, traditional server-virtualization techniques, such as those used in enterprise IT. A virtualized network function (VNF) may consist of one or more virtual machines running different software and processes, on top of standard high-volume servers, switches and storage devices, or even cloud computing infrastructure, instead of having custom hardware appliances for each network function. For example, a virtual session border controller could be deployed to protect a network domain without the typical cost and complexity of obtaining and installing physical network protection units. Other examples of NFV include virtualized load balancers, firewalls, intrusion detection devices and WAN accelerators.

The NFV framework consists of three main components:

Virtualized network functions (VNFs) are software implementations of network functions that can be deployed on a network functions virtualization infrastructure (NFVI).

Network functions virtualization infrastructure (NFVI) is the totality of all hardware and software components that build the environment where VNFs are deployed. The NFV infrastructure can span several locations. The network providing connectivity between these locations is considered as part of the NFV infrastructure.

Network functions virtualization MANagement and Orchestration (MANO) architectural framework (NFV-MANO Architectural Framework) is the collection of all functional blocks, data repositories used by these blocks, and reference points and interfaces through which these functional blocks exchange information for the purpose of managing and orchestrating NFVI and VNFs.

The building block for both the NFVI and the NFV-MANO is the NFV platform. In the NFVI role, it consists of both virtual and physical processing and storage resources, and virtualization software. In its NFV-MANO role it consists of VNF and NFVI managers and virtualization software operating on a hardware controller. The NFV platform implements carrier-grade features used to manage and monitor the platform components, recover from failures and provide effective security—all required for the public carrier network.

Software-Defined Topology (SDT) is a logical network topology that may be used to implement a given network service instance. For example, for a cloud based database service, an SDT may comprise logical links between a client and one or more instances of a database service. As the name implies, an SDT will typically be generated by one or more software applications executing on a server. Logical topology determination is done by the SDT which prepares the Network Service Infrastructure (NSI) descriptor (NSLD) as the output. It may use an existing template of an NSI and add parameter values to it to create the NSLD, or it may create a new template and define the composition of the NSI.

Software Defined Protocol (SDP) is a logical End-to End (E2E) protocol that may be used by a given network service instance. For example, for a cloud based database service, an SDP may define a network slice to be used for communications between the client and each instance of the database service. As the name implies, an SDP will typically be generated by one or more software applications executing on a server.

Software-Defined Resource Allocation (SDRA) refers to the allocation of network resources for logical connections in the logical topology associated with a given service instance. For example, for a cloud based database service, an SDRA may use service requirements (such as Quality of Service, latency, etc) to define an allocation of physical network resources to the database service. As the name implies, an SDRA will typically be generated by one or more software applications executing on a server.

Service Oriented Network Auto Creation (SONAC) utilizes software-defined topology (SDT), software defined protocol (SDP), and software-defined resource allocation (SDRA) to create a network or virtual network for a given network service instance. In some cases, SONAC may be used to create a 3rd Generation Partnership Project (3GPP) slice using a virtualized infra-structure (SDT, SDP, and SDRA) to provide a Virtual Network (VN) service to an external customer. SONAC may be used to optimize the Network Management, and so may also be considered to be a Network Management (NM) optimizer.

Architecture options needed for the management plane in carrying out the tasks of SONAC are highly desirable.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide architecture options needed for the management plane in carrying out the tasks of Network Management optimization.

Accordingly, an aspect of the present invention provides a method for managing a communications network includes providing a parent network manager in a parent domain of the communications network, and providing a child network manager in a child domain of the communications network. The parent network manager comprises at least one of a parent Service Oriented Network Auto Creation (SONAC) function and a parent MANagement and Orchestration (MANO) function. The child network manager comprises at least one of a child Service Oriented Network Auto Creation (SONAC) function and a child MANagement and Orchestration (MANO) function. The parent and child network managers cooperate to optimize management of the parent and child domains of the communications network.

### BRIEF DESCRIPTION OF THE FIGURES

Further features and advantages of the present invention will become apparent from the following detailed description, taken in combination with the appended drawings, in which:

FIG. 1 is a block diagram of a computing system 100 that may be used for implementing devices and methods in accordance with representative embodiments of the present invention;

FIG. 2 is a block diagram schematically illustrating an architecture of a representative server usable in embodiments of the present invention;

FIGS. 3A and 3B are block diagrams schematically illustrating hierarchical network management in accordance with representative embodiments of the present invention;

FIG. 4 is a block diagram schematically illustrating an example interworking option between SONAC and MANO in accordance with representative embodiments of the present invention;

FIG. 5 is a block diagram schematically illustrating a second example interworking option between SONAC and MANO in accordance with representative embodiments of the present invention;

FIG. 6 is a block diagram schematically illustrating a third example interworking option between SONAC and MANO in accordance with representative embodiments of the present invention;

FIG. 7 is a block diagram schematically illustrating a third example interworking option between SONAC and MANO in accordance with representative embodiments of the present invention;

FIG. 8 is a chart illustrating example combinations of the example interworking options of FIGS. 4-7 usable in embodiments of the present invention;

FIG. 9 is a block diagram schematically illustrating an example interworking between parent and child domains in accordance with representative embodiments of the present invention;

FIG. 10 is a block diagram schematically illustrating a second example interworking between parent and child domains in accordance with representative embodiments of the present invention;

FIG. 11 is a block diagram schematically illustrating a third example interworking between parent and child domains in accordance with representative embodiments of the present invention;

FIG. 12 is a block diagram schematically illustrating hierarchical network management in accordance with further representative embodiments of the present invention;

FIG. 13 is a chart illustrating example combinations of interworking options in the hierarchical network management of FIG. 12;

FIG. 14 is a block diagram schematically illustrating a fourth example interworking between parent and child domains in accordance with representative embodiments of the present invention; and

FIG. 15 is a block diagram schematically illustrating a fifth example interworking between parent and child domains in accordance with representative embodiments of the present invention.

It will be noted that throughout the appended drawings, like features are identified by like reference numerals.

### DETAILED DESCRIPTION

The 3rd Generation Partnership Project (3GPP) system needs to use a common Virtualized infra-structure for its VNF instantiation and associated resources. The virtualized infra-structure may be distributed at different geographical locations and under different Data Centers (DCs) controlled by their own local MANOs. For the purposes of the present disclosure, the term Data Center (DC) shall be understood to refer to any network domain capable of operating under the control of a local MANO and/or SONAC, whether or not such domain actually is doing so.

What is needed is a mechanism to use these resources for the 3GPP slices and services. However, there can be common VNFs, Network Elements (NEs) or other resources used by multiple services or slices and their usage may be dynamically controlled for different 3GPP slices and/or 3GPP services.

Various measurements and reporting needs to be done on resource usage by these VNFs and NEs specific to 3GPP services or slices. ETSI NFV MANO uses Network Services to segregate different 3GPP slices or services.

The present disclosure provides several mechanisms to use VNF instantiation and associated resources across different domain-level Network Management (NM) systems in a hierarchical manner. Each of these mechanisms is described below.

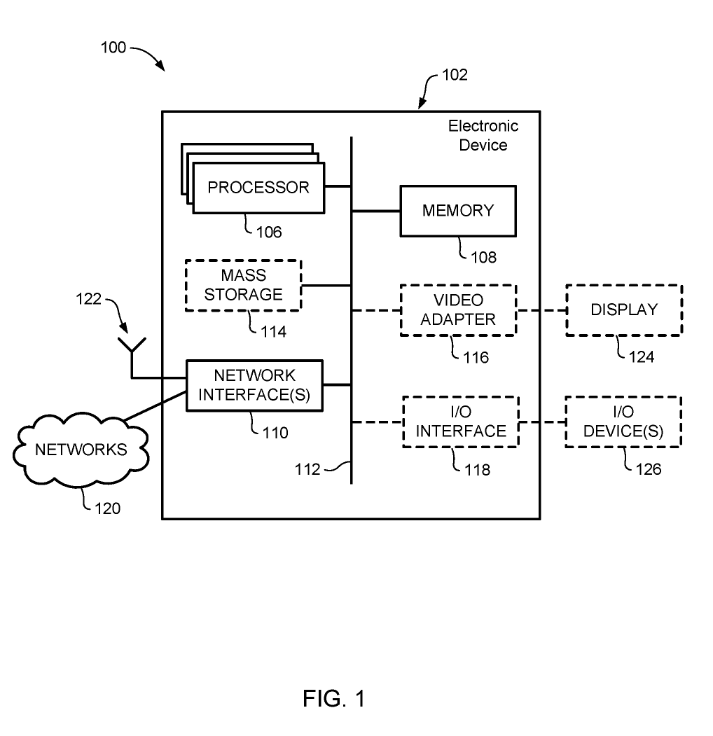

FIG. 1 is a block diagram of a computing and communication system 100 that may be used for implementing the devices and methods disclosed herein. Specific devices may utilize all of the components shown or only a subset of the components, and levels of integration may vary from device to device. Furthermore, a device may contain multiple instances of a component, such as multiple processing units, processors, memories, transmitters, receivers, etc. The computing and communication system 100 includes a processing unit or electronic device (ED) 102. The electronic device 102 typically includes a processor 106, memory 108, and one or more network interfaces 110 connected to a bus 112, and may further include a mass storage device 114, a video adapter 116, and an I/O interface 118.

The bus 112 may be one or more of any type of several bus architectures including a memory bus or memory controller, a peripheral bus, or a video bus. The processor 106 may comprise any type of electronic data processor. The memory 108 may comprise any type of non-transitory system memory such as static random access memory (SRAM), dynamic random access memory (DRAM), synchronous DRAM (SDRAM), read-only memory (ROM), or a combination thereof. In specific embodiments, the memory 108 may include more than one type of memory, such as ROM for use at boot-up, and DRAM for program and data storage for use while executing programs.

The mass storage 114 may comprise any type of non-transitory storage device configured to store data, programs, and other information and to make the data, programs, and other information accessible via the bus 112. The mass storage 114 may comprise, for example, one or more of a solid state drive, hard disk drive, a magnetic disk drive, or an optical disk drive.

The video adapter 116 and the I/O interface 118 provide optional interfaces to couple external input and output devices to the ED 102. Examples of input and output devices include a display 124 coupled to the video adapter 116 and an I/O device 126 such as a touch screen coupled to the I/O interface 118. Other devices may be coupled to the ED 102, and additional or fewer interfaces may be utilized. For example, a serial interface such as Universal Serial Bus (USB) (not shown) may be used to provide an interface for an external device.

The electronic device 102 also includes one or more network interfaces 110, which may comprise wired links and/or wireless links to access one or more networks 120 or other devices. The network interfaces 110 allow the electronic device 102 to communicate with remote units via the networks 120. For example, the network interfaces 110 may provide wireless communication via one or more transmitters/transmit antennas and one or more receivers/receive antennas (collectively referenced at 122 in FIG. 1). In an embodiment, the electronic device 102 is coupled to a local-area network 120 or a wide-area network for data processing and communications with remote devices, such as other electronic devices, the Internet, or remote storage facilities.

In some embodiments, electronic device 102 may be a standalone device, while in other embodiments electronic device 102 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools computing and storage resources connected to each by connectivity resources. The connectivity resources may take the form of physical connections such as Ethernet or optical communications links, and may include wireless communication channels as well. If two different data centers are connected by a plurality of different communication channels, the links can be combined together using any of a number of techniques including the formation of link aggregation groups (LAGs). It should be understood that any or all of the computing, storage and connectivity resources (along with other resources within the network) can be divided between different sub-networks, in some cases in the form of a resource slice. If the resources across a number of connected data centers or other collection of nodes are sliced, different network slices can be created.

In some embodiments, the electronic device 102 may be an element of communications network infrastructure, such as a base station (for example a NodeB, an enhanced Node B (eNodeB), a next generation NodeB (sometimes referred to as a gNodeB or gNB), a home subscriber server (HSS), a gateway (GW) such as a packet gateway (PGW) or a serving gateway (SGW) or various other nodes or functions within an evolved packet core (EPC) network. In other embodiments, the electronic device 102 may be a device that connects to network infrastructure over a radio interface, such as a mobile phone, smart phone or other such device that may be classified as a User Equipment (UE). In some embodiments, ED 102 may be a Machine Type Communications (MTC) device (also referred to as a machine-to-machine (m2m) device), or another such device that may be categorized as a UE despite not providing a direct service to a user. In some references, an ED 102 may also be referred to as a mobile device (MD), a term intended to reflect devices that connect to mobile network, regardless of whether the device itself is designed for, or capable of, mobility.

The processor 106, for example, may be provided as any suitable combination of: one or more general purpose micro-processors and one or more specialized processing cores such as Graphic Processing Units (GPUs) or other so-called accelerated processors (or processing accelerators).

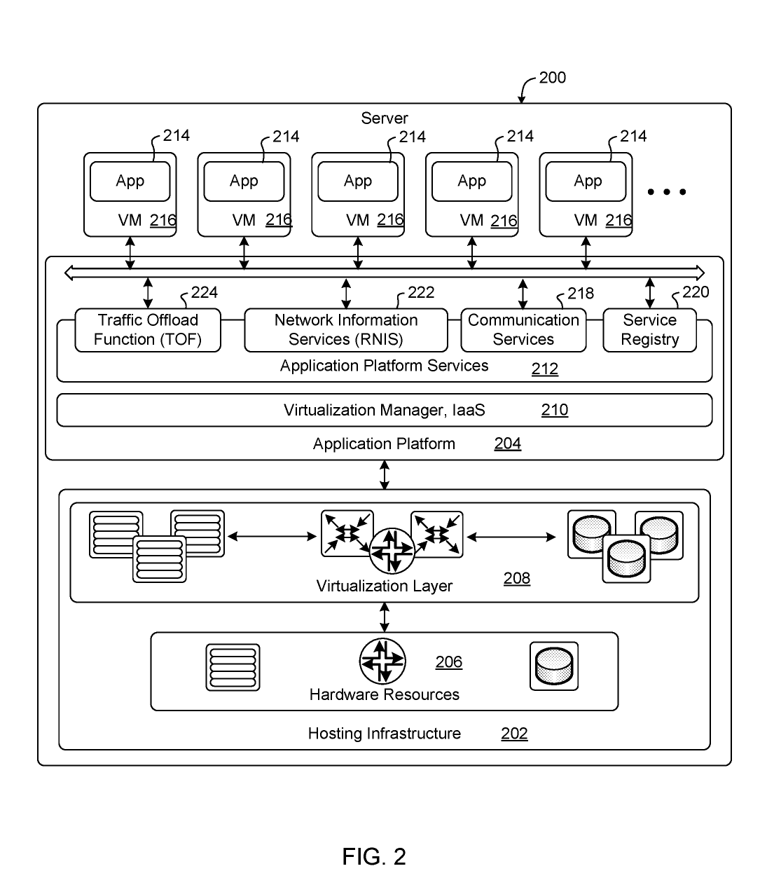

FIG. 2 is a block diagram schematically illustrating an architecture of a representative server 200 usable in embodiments of the present invention. It is contemplated that the server 200 may be physically implemented as one or more computers, storage devices and routers (any or all of which may be constructed in accordance with the system 100 described above with reference to FIG. 1) interconnected together to form a local network or cluster, and executing suitable software to perform its intended functions. Those of ordinary skill will recognize that there are many suitable combinations of hardware and software that may be used for the purposes of the present invention, which are either known in the art or may be developed in the future. For this reason, a figure showing the physical server hardware is not included in this specification. Rather, the block diagram of FIG. 2 shows a representative functional architecture of a server 200, it being understood that this functional architecture may be implemented using any suitable combination of hardware and software. As maybe seen in FIG. 2, the illustrated server 200 generally comprises a hosting infrastructure 202 and an application platform 204. The hosting infrastructure 202 comprises the physical hardware resources 206 (such as, for example, information processing, traffic forwarding and data storage resources) of the server 200, and a virtualization layer 208 that presents an abstraction of the hardware resources 206 to the Application Platform 204. The specific details of this abstraction will depend on the requirements of the applications being hosted by the Application layer (described below). Thus, for example, an application that provides traffic forwarding functions may be presented with an abstraction of the hardware resources 206 that simplifies the implementation of traffic forwarding policies in one or more routers. Similarly, an application that provides data storage functions may be presented with an abstraction of the hardware resources 206 that facilitates the storage and retrieval of data (for example using Lightweight Directory Access Protocol—LDAP).

The application platform 204 provides the capabilities for hosting applications and includes a virtualization manager 210 and application platform services 212. The virtualization manager 210 supports a flexible and efficient multi-tenancy run-time and hosting environment for applications 214 by providing Infrastructure as a Service (IaaS) facilities. In operation, the virtualization manager 210 may provide a security and resource “sandbox” for each application being hosted by the platform 204. Each “sandbox” may be implemented as a Virtual Machine (VM) image 216 that may include an appropriate operating system and controlled access to (virtualized) hardware resources 206 of the server 200. The application-platform services 212 provide a set of middleware application services and infrastructure services to the applications 214 hosted on the application platform 204, as will be described in greater detail below.

Applications 214 from vendors, service providers, and third-parties may be deployed and executed within a respective Virtual Machine 216. For example, MANagement and Orchestration (MANO) functions and Service Oriented Network Auto-Creation (SONAC) functions (or any of Software Defined Networking (SDN), Software Defined Topology (SDT), Software Defined Protocol (SDP), and Software Defined Resource Allocation (SDRA) controllers) may be implemented by means of one or more applications 214 hosted on the application platform 204 as described above. Communication between applications 214 and services in the server 200 may conveniently be designed according to the principles of Service-Oriented Architecture (SOA) known in the art.

Communication services 218 may allow applications 214 hosted on a single server 200 to communicate with the application-platform services 212 (through pre-defined Application Programming Interfaces (APIs) for example) and with each other (for example through a service-specific API).

A Service registry 220 may provide visibility of the services available on the server 200. In addition, the service registry 220 may present service availability (e.g. status of the service) together with the related interfaces and versions. This may be used by applications 214 to discover and locate the end-points for the services they require, and to publish their own service end-point for other applications to use.

Mobile-edge Computing allows cloud application services to be hosted alongside mobile network elements, and also facilitates leveraging of the available real-time network and radio information. Network Information Services (NIS) 222 may provide applications 214 with low-level network information. For example, the information provided by MS 222 may be used by an application 214 to calculate and present high-level and meaningful data such as: cell-ID, location of the subscriber, cell load and throughput guidance.

A Traffic Off-Load Function (TOF) service 224 may prioritize traffic, and route selected, policy-based, user-data streams to and from applications 214. The TOF service 224 may be supplied to applications 224 in various ways, including: A Pass-through mode where (uplink and/or downlink) traffic is passed to an application 214 which can monitor, modify or shape it and then send it back to the original Packet Data Network (PDN) connection (e.g. 3GPP bearer); and an End-point mode where the traffic is terminated by the application 214 which acts as a server.

The virtualization layer 208 and the application platform 204 may be collectively referred to as a Hypervisor.

It will also be understood that server 200 may itself be a virtualized entity. Because a virtualized entity has the same properties as a physical entity from the perspective of another node, both virtualized and physical computing platforms may serve as the underlying resource upon which virtualized functions are instantiated.

MANO, (SONAC), SDN, SDT, SDP and SDRA functions may in some embodiments be incorporated into a SONAC controller.

As may be appreciated, the server architecture of FIG. 2 is an example of Platform Virtualization, in which each Virtual Machine 216 emulates a physical computer with its own operating system, and (virtualized) hardware resources of its host system. Software applications 214 executed on a virtual machine 216 are separated from the underlying hardware resources 206 (for example by the virtualization layer 208 and Application Platform 204). In general terms, a Virtual Machine 216 is instantiated as a client of a hypervisor (such as the virtualization layer 208 and application-platform 204) which presents an abstraction of the hardware resources 206 to the Virtual Machine 216.

Other virtualization technologies are known or may be developed in the future that may use a different functional architecture of the server 200. For example, Operating-System-Level virtualization is a virtualization technology in which the kernel of an operating system allows the existence of multiple isolated user-space instances, instead of just one. Such instances, which are sometimes called containers, virtualization engines (VEs) or jails (such as a “FreeBSD jail” or “chroot jail”), may emulate physical computers from the point of view of applications running in them. However, unlike virtual machines, each user space instance may directly access the hardware resources 206 of the host system, using the host systems kernel. In this arrangement, at least the virtualization layer 208 of FIG. 2 would not be needed by a user space instance. More broadly, it will be recognised that the functional architecture of a server 200 may vary depending on the choice of virtualisation technology and possibly different vendors of a specific virtualisation technology.

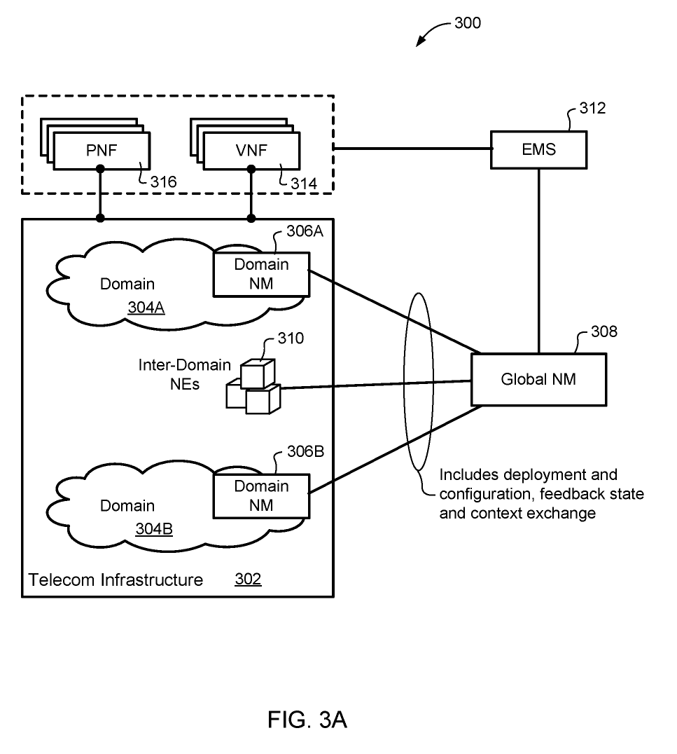

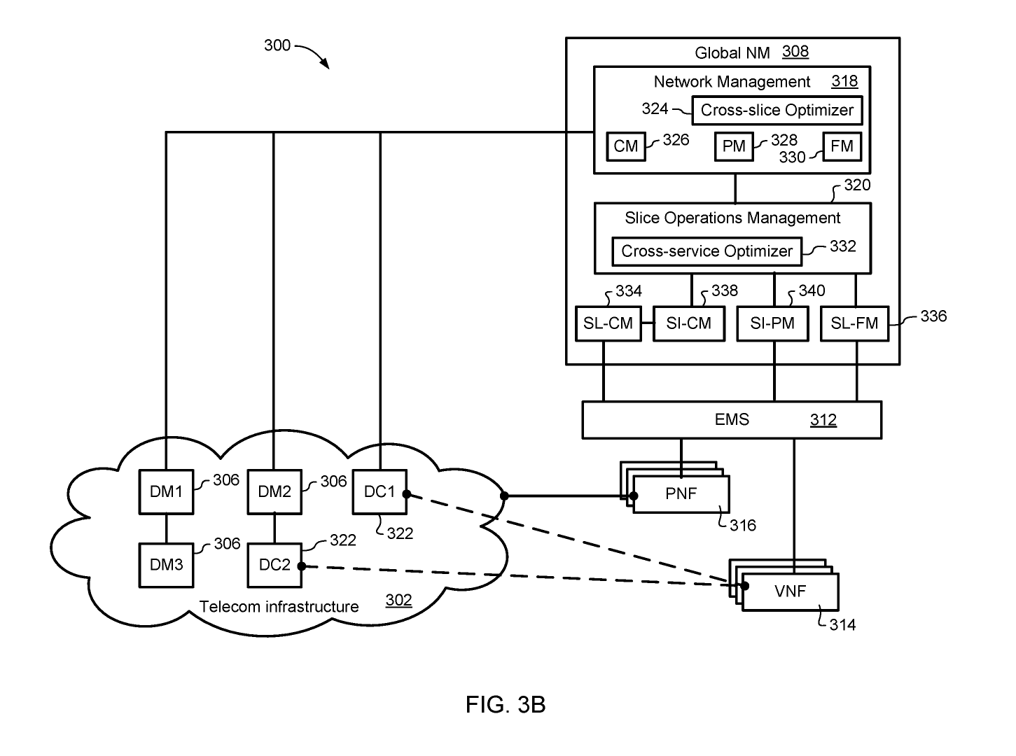

FIGS. 3A and 3B are block diagrams schematically illustrating hierarchical network management in accordance with representative embodiments of the present invention. In the example of FIG. 3A, the communications network 300 is composed of Telecom-Infrastructure 302, which may be separated into a plurality of domains 304. Each domain 304 is individually managed by a respective Domain Manager (DM) 306. The entire network 300 is managed by a central Global Network Manager (GNM) 308, with the assistance of the DMs 306. The GNM 308 may also directly manage inter-domain Network Elements (NEs) 310, that are not directly managed by any DMs 306. With this arrangement, the DNM 308 can be considered to constitute a Parent Domain, while each separately managed domain 304 of the network 300 can be considered to constitute a respective Child Domain. FIG. 3A also illustrates an Element Management System 312, which may interact with the GNM 308 to manage Virtual Network Functions (VNFs) 314 and Physical Network Functions (PNFs) 316 of the Telecom Infrastructure 302.

FIG. 3B illustrates an alternative view of the hierarchical network management system of FIG. 3A, in which elements of the GNM 308 are shown in greater detail. As may be seen in FIG. 3B, the GNM 308 may comprise a Network Manager (NM) 318 and a Slice Manager (SLM) 320. The NM 318 may interact directly with the DMs 306 and Data Centers (DCs) 322 of the Telecom Infrastructure 302 to provide global network management. In the illustrated embodiment, the NM 318 includes a Cross-slice Optimizer 324, a configuration manager (CM) 326, a Performance Manager (PM) 328, and a Fault Manager (FM) 330. The Cross-slice Optimizer 322 may operate to optimize allocations of network resources across two or more slices. The CM 326, PM) 328, and FM 330 may operate to provide configuration, performance and fault management functions as will be described in greater detail below.

The SLM 320 may include a Cross-service Optimizer 332 a Slice configuration manager (SL-CM) 334, a Slice Fault Manager (SL-FM) 336, a Service Instance-specific Configuration Manager (SI-CM) 338 and a Service Instance-specific Performance Manager (SI-PM) 340. The Cross-service Optimizer 332 may operate to optimize, for each slice, the allocation of slice resources to one or more services. The SL-CM 334, SL-FM 336, SI-CM 338 and SI-PM 340 may operate to provide slice-specific configuration and fault management functions, and Service-Instance-specific configuration and performance management functions as will be described in greater detail below.

At each layer of the management hierarchy there are four network management options, depending on the interworking mechanism of SONAC and MANO. These options are as follows:

Option 1: SONAC interacts with enhanced MANO. In this option, the MANO NFVO interface is enhanced to accept SONAC commands as service requests or service request updates. (i.e. 0-intelligence MANO)

Option 2. SONAC-in-MANO. In this case, the MANO NFVO functionality is enhanced to allow forwarding of graph modification within the MANO entity.

Option 3. SONAC works alone without the assistance from MANO. This option is applicable only to the telecom network

Option 4. MANO works alone without the assistance from SONAC. This option is applicable only to Data Center (DC) networks.

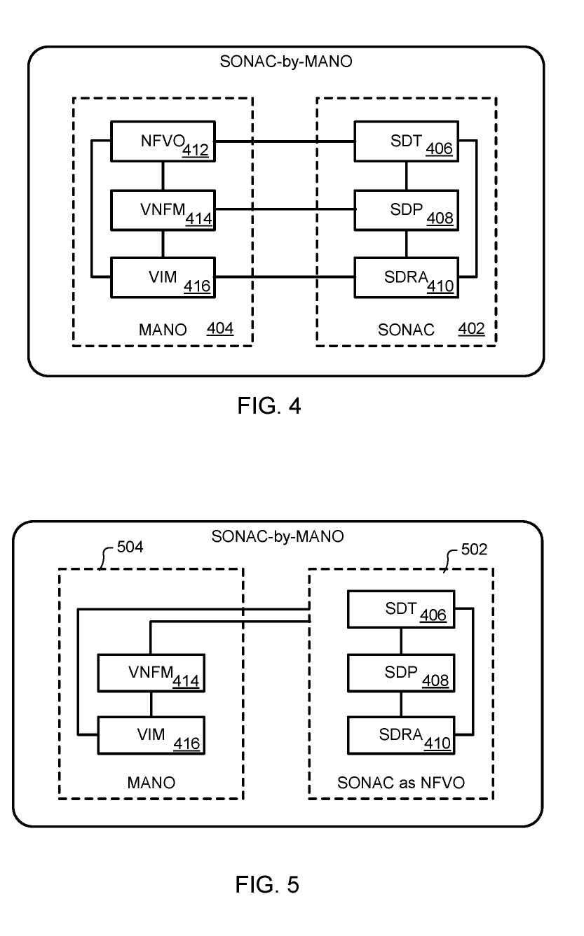

FIG. 4 is a block diagram schematically illustrating an example interworking option (corresponding to Option 1 above) between SONAC 402 and MANO 404 in accordance with representative embodiments of the present invention. In the interworking option of FIG. 4, the MANO function 404 is enhanced by configuring its Network Function Virtualization Orchestrator (NFVO) 412 to receive topology information from the Software Defined Topology (SDT) function 406 of the SONAC 402 as a network service request. In some embodiments this network service request may be formatted as defined by ETSI. Similarly, the VNFM 414 of the MANO 404 may be configured to receive protocol information from the SDP controller 408 of the SONAC 402, while the VIM 416 of the MANO 404 may be configured to receive resource allocation data from the SDRA 410 of the SONAC 402.

In some embodiments, the SONAC and MANO may be co-resident in a common network manager (e.g. either one or both of the GNM 308 or a DNM 306). In other embodiments the SONAC may be resident in the GNM 308, while the MANO is resident in a DNM 306, or vice versa. In the illustrated example, the SONAC 402 is represented by a Software Defined Topology (SDT) controller 406, a Software Defined Protocol (SDP) controller 408 and a Software Defined Resource Allocation (SDRA) controller 410, while the MANO 404 is represented by a Network Function Virtualization Orchestrator (NFVO) 412, an Virtual Network Function Manager (VNFM) 414 and a Virtualized Infrastructure Manager 416). The SDT controller 406, SDP controller 408 and SDRA controller 410 of the SONAC 402 interact with each other to implement optimization of the network or network domain controlled by the SONAC 402. Similarly, the NFVO 412, VNFM 414 and VIM 416 of the MANO 404 interact with each other to implement network function management within the network or network domain controlled by the MANO 404. In some embodiments, each of the NFVO 412, VNFM 414 and VIM 416 of the MANO 404 may configured to interact directly with the SDT controller 406, SDP controller 408 and SDRA controller 410 of the SONAC 402.

FIG. 5 is a block diagram schematically illustrating a second example interworking option (corresponding to Option 2 above) between a SONAC 502 and a MANO 504 in accordance with representative embodiments of the present invention. In the interworking option of FIG. 5, the SONAC 502 is configured to provide the functionality of the MANO's Network Function Virtualization Orchestrator (NFVO) 412, which is therefore replaced by the SONAC. In such cases, the VNFM 414 and VIM 416 of the MANO 504 may be configured to interact with the SONAC 502 in place of the (omitted) NFVO 412 in order to obtain the Orchestration functions normally provided by the NFVO 412.

In some embodiments, the SONAC 502 and MANO 504 may be co-resident in a common network manager (e.g. either one or both of the GNM 308 or a DNM 306). In other embodiments the SONAC may be resident in the GNM 308, while the MANO is resident in a DNM 306, or vice versa. The SONAC 502 and MANO 504 are similar to the SONAC 402 and MANO 404 of FIG. 4, except that

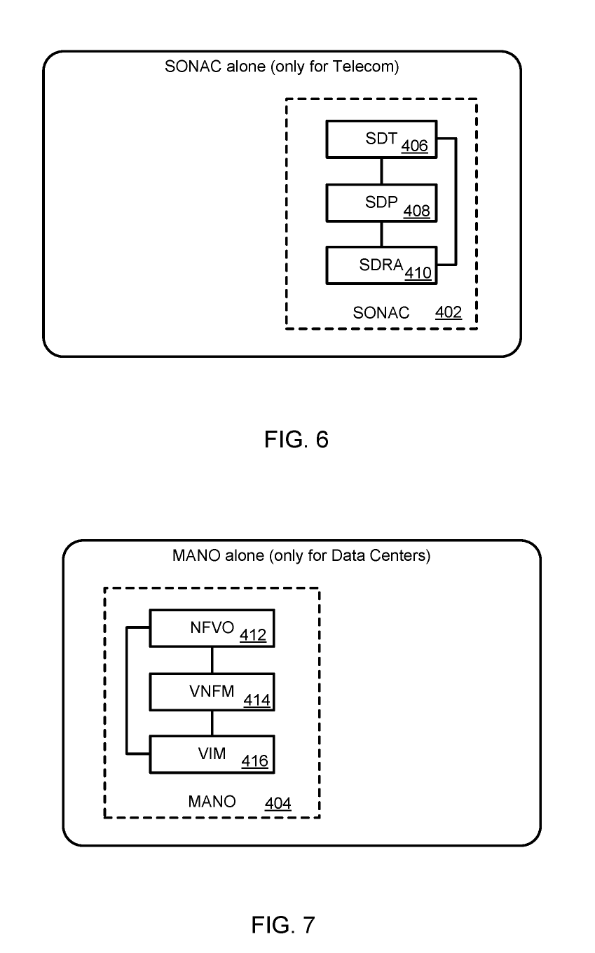

FIG. 6 is a block diagram schematically illustrating a third example interworking option (corresponding to Option 3 above) between SONAC and MANO in accordance with representative embodiments of the present invention. In the interworking option of FIG. 6, the MANO is omitted. This option may be implemented in a Parent Domain NM 308 for interacting with Child domain NM 306.

FIG. 7 is a block diagram schematically illustrating a fourth example interworking option (corresponding to Option 4, above) between SONAC and MANO in accordance with representative embodiments of the present invention. In the interworking option of FIG. 7, the SONAC is omitted. This option may be implemented in a Child Domain NM for interacting with a Parent Domain NM.

Information sent from a DM 306 to the NM 318 (e.g. the CM 326) for Domain abstraction may include:
Number of Virtual machines (VMs); number of CPUs (and per CPU processing speed), memory, disk storage, maximum disk IOPS (in bits or bytes per second);
incoming line cards, outgoing line cards, per line card IOPS (in bits or bytes per second);
average internal packet switching delay (in number of packets per second, from one incoming line card to one out going line card) or per in/out line card pair packet switching delay.

Information sent from a DM 306 to the NM 318 (e.g. the CM 326) for Domain exposure may include:
Domain network topology
Node capability: which may comprise the same information described above for domain abstraction, and, in the case of a radio node, the number of Radio Bearers (RBs) and the maximum transmit power;
Link capability: which may include bandwidth; and, in the case of a wireless link, the (average) spectral efficiency.

Information exchanged between a DM 306 and the NM 318 (e.g. the CM 326) for NFV negotiation may include:
From NM to DM: A proposal including Network Functions (NFs) to be hosted, NF-specific properties (such as impact on traffic rate), NF-specific compute resource requirements, NF interconnection and associated QoS requirements, ingress NF (and possibly desired ingress line card), egress NF (and possibly desired egress line card), per line card maximum rate support needed for incoming or outgoing traffic.
From DM to NM: A Notification of proposal acceptance; or a counter proposal; or Cost update (or initialization) including per-NF hosting cost, NF-specific compute resource allocation, ingress line card, ingress traffic rate and cost, egress line card, egress traffic rate and cost.

Information sent from the NM 318 (e.g. the CM 326) to a DM 306 for NE configuration common to all slices, or from the SLM 320 to a DM 306 for NE configuration (per service or per slice), may include:
In the case of domain abstraction:
   NFs to be hosted, NF interconnection and associated QoS requirements, ingress NF (and possibly desired incoming line card to be used for the NF), egress NF (and possibly desired outgoing line card to be used for the NF), per line card maximum rate support needed for incoming or outgoing traffic, and in the case of virtualization, NF-specific properties (including impact on traffic rate), NF-specific compute resource requirements
   NF-specific operation parameter configuration
In the case of domain exposure:
   NF location within the domain, NF interconnection and associated QoS requirements, ingress NF (and desired incoming line card to be used for the NF), egress NF (and desired outgoing line card to be used for the NF), per line card maximum rate support needed for incoming or outgoing traffic, and in the case of virtualization, NF-specific properties (including impact on traffic rate), NF-specific compute resource requirements
   NF-specific operation parameter configuration

Information sent from the NM 318 (e.g. the PM 328 and/or FM 330) to a DM 306 for network-level NF-specific performance/fault monitoring configuration common to all slices, or from the SLM 320 to a DM 306 for NF-specific performance/fault monitoring configuration (per service or per slice), may include:
Time intervals for performance report, to enable periodic reporting, for example. In some embodiments, a predetermined value, such as “infinity”, may indicate that reporting is disabled.
Threshold values for performance report, for example to enable performance change (either increase or decrease) triggers reporting. In some embodiments, a predetermined value, such as “infinity”, may indicate that reporting is disabled.
Threshold values for fault alarm, such as, for example, a Performance degradation threshold.

In some embodiments, a predetermined value, such as “infinity”, may indicate that alarm is disabled.

Information sent from the DM 306 to the SLM 320 (e.g. the SI-PM 340) for per-service and/or per-slice performance monitoring may include:
In the case of domain abstraction:
   line card performance, such as Per line card IO delay.
   Internal switching performance, such as internal packet switching delay (in number of packets per second, from one incoming line card to one out going line card) or per in/out line card pair packet switching delay.
   compute performance (per NF or overall), such as the number of VMs used (or available), number of CPUs used (or available), disk storage occupied (or available), disk IO delay
In the case of domain exposure:
   Per node performance information similar to that described above for the case of domain abstraction; and in the case of a radio node, the number of Radio Bearers (RBs) used (or available)
   Per link performance: bandwidth used (or available); if wireless link, (average) spectral efficiency

Information sent from a DM 306 to the ND 318 (e.g. the FM 330) for network-level fault alarming common to all slices, or from a DM 306 to the SLM 320 (e.g. the SL-FM 336) for per service or per slice fault alarming, may include:
In the case of domain abstraction
   line card failure
   Internal switching failure for a particular in-out line card pair
   compute failure (per NF)
In the case of domain exposure
   Node failure
   Link failure

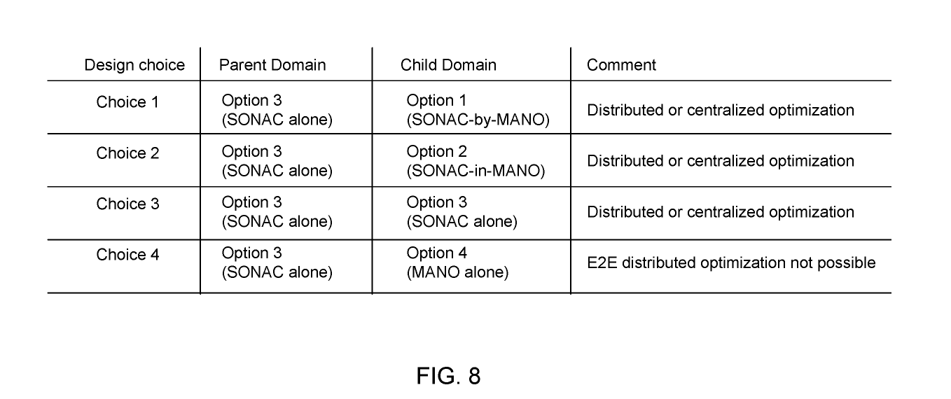

FIG. 8 is a chart illustrating four example combinations of the example interworking options of FIGS. 4-7 usable in embodiments of the present invention. In each of the illustrated example combinations, the interworking Option 3 illustrated in FIG. 6 is implemented in the Parent Domain NM 308, while each of the interworking Options 1-4 illustrated in FIGS. 4-7 are implemented in the Child Domain NM 306. As may be seen in FIG. 8, both distributed and centralized optimization of network management are possible when the interworking Options 1-3illustrated in FIGS. 4-6 are implemented in the Child Domain NM. On the other hand, when the interworking option illustrated in FIG. 7 (Option 4) is implemented in the Child Domain NM 306, End-to-End (E2E) distributed optimization of network management may not be possible. However, if the Child Domain NM 306 is provisioned with an exposure function, such that functions and locations in the Child Domain 304 are visible to the Parent Domain NM 308, then centralized optimization may be possible.

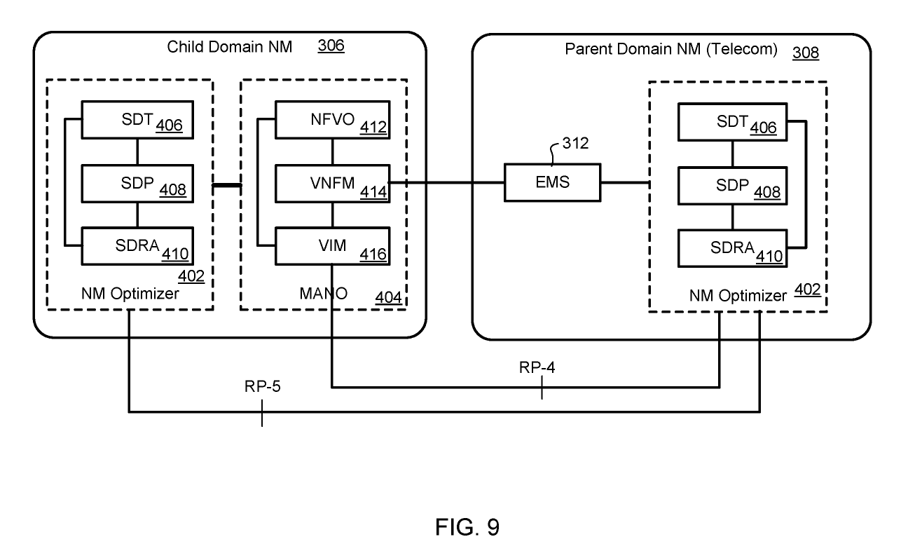

FIG. 9 is a block diagram schematically illustrating an example interworking between parent and child domain network managers 308 and 306 in accordance with representative embodiments of the present invention. The arrangement of FIG. 9 illustrates example interworking combination Design Choice 1 from the chart of FIG. 8. With this arrangement, the Child Domain 304 may be represented to the Parent Domain NM 308 as an NFV-capable virtual node or virtual server. In this case, the Child Domain NM 306 may provide an abstraction of the Child Domain 304 to the Parent Domain NM 308, for example via RP-4, which can then provide centralized network management optimization. Alternatively, the Child Domain NM 306 may not provide any information of the Child Domain 304 to the Parent Domain NM 308, but rather interact with the Parent Domain NM 308 to perform network management optimization via RP-5. It will be appreciated that example interworking combination Choice 2 from the chart of FIG. 8 is closely similar.

FIG. 9 illustrates a further alternative, in which the child domain NM 306 interacts with the parent domain NM 308 via the EMS 312 to implement network management optimization

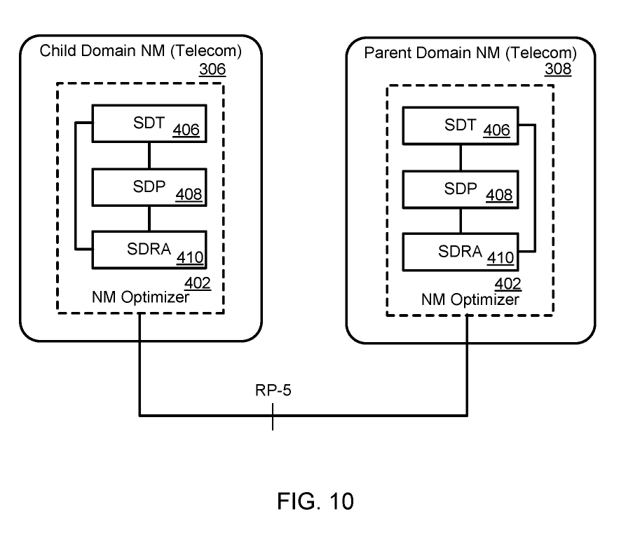

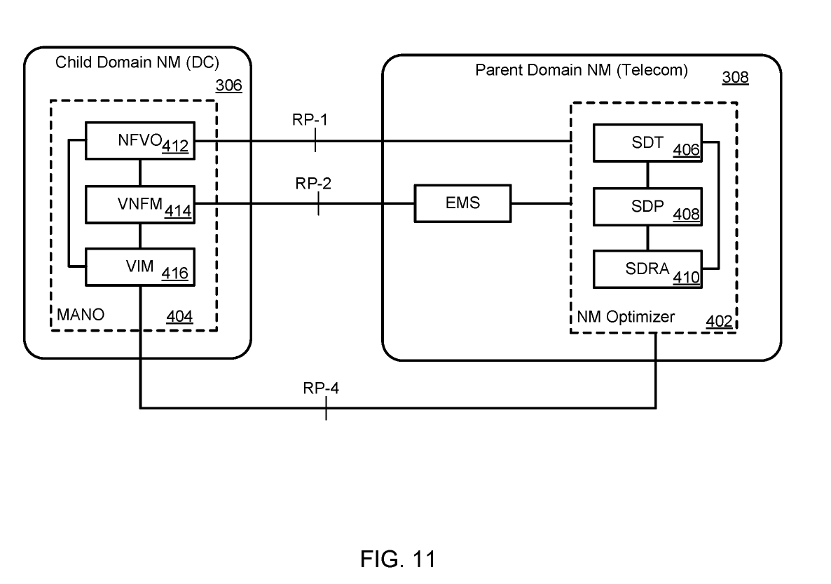

FIG. 10 is a block diagram schematically illustrating a second example interworking between parent and child domains in accordance with representative embodiments of the present invention. The arrangement of FIG. 10 illustrates example interworking combination Choice 3 from the chart of FIG. 8. As in the embodiments of FIG. 9, the Child Domain 304 may be represented to the Parent Domain NM 308 as an NFV-capable virtual node or virtual server. In this case, the Child Domain NM 306 may provide an abstraction of the Child Domain 304 to the Parent Domain NM 308, for example via RP-5, which can then provide centralized network management optimization. Alternatively, the Child Domain NM 306 may not provide any information of the Child Domain 304 to the Parent Domain NM 308, but rather interact with the Parent Domain NM 308 to perform network management optimization.

FIG. 11 is a block diagram schematically illustrating a third example interworking between parent and child domains in accordance with representative embodiments of the present invention. The arrangement of FIG. 11 illustrates example interworking combination Choice 4 from the chart of FIG. 8. As in the embodiments of FIG. 9, the Child Domain 304 may be represented to the Parent Domain NM 308 as an NFV-capable virtual node or virtual server. In this case, the Child Domain NM 306 may provide an abstraction of the Child Domain 304 to the Parent Domain NM 308, for example via RP-4, which can then provide centralized network management optimization. Alternatively, the Child Domain NM 306 may provide detailed information of the Child Domain 304 to the Parent Domain NM 308, and execute instructions from the Parent Domain NM 308 to implement network management optimization within the Child Domain 304.

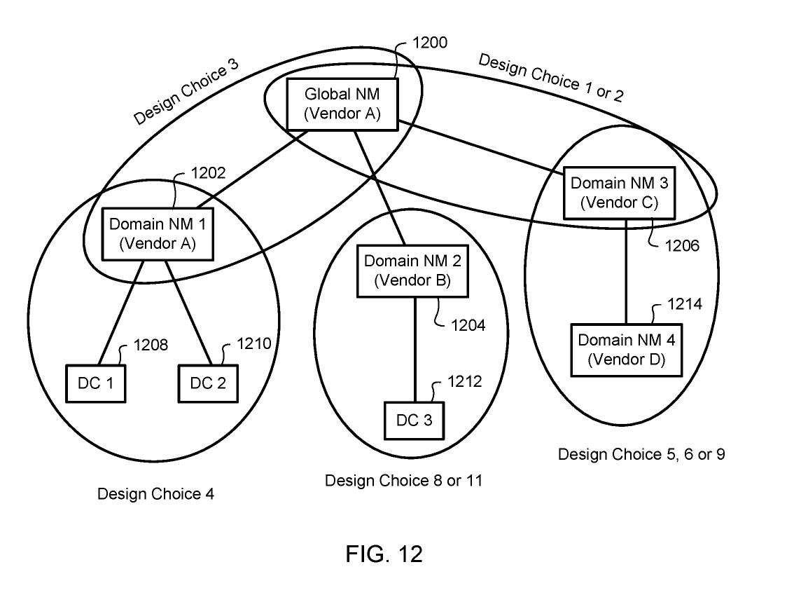

FIG. 12 is a block diagram schematically illustrating hierarchical network management in accordance with further representative embodiments of the present invention. In the example of FIG. 12, the network is logically divided into three layers. Each layer represents child domains of the layer above it, and parent domains of the layer below it. The ellipses shown in FIG. 12 illustrate parent-child relationships between the NM entities in each layer, and further identify the interworking combinations between the involved entities. This arrangement is suitable in network environments in which NM entities (servers, nodes, etc.) may be provided by different vendors.

In the example of FIG. 12, the interworking choices described above with reference to FIGS. 8-11 may be implemented between the Global NM 1200, and each of Domain NM 1 2102, Domain NM 2 1204 and Domain NM 3 1206, and between Domain NM 1 1202 and each of the Domains DC1 1208 and DC2 1210. Further interworking choices may be implemented, for example between Domain NM 2 1204 and Domain DC3 1212 and between Domain NM 3 1206 and Domain NM 4 1214, as will be described in further detail below.

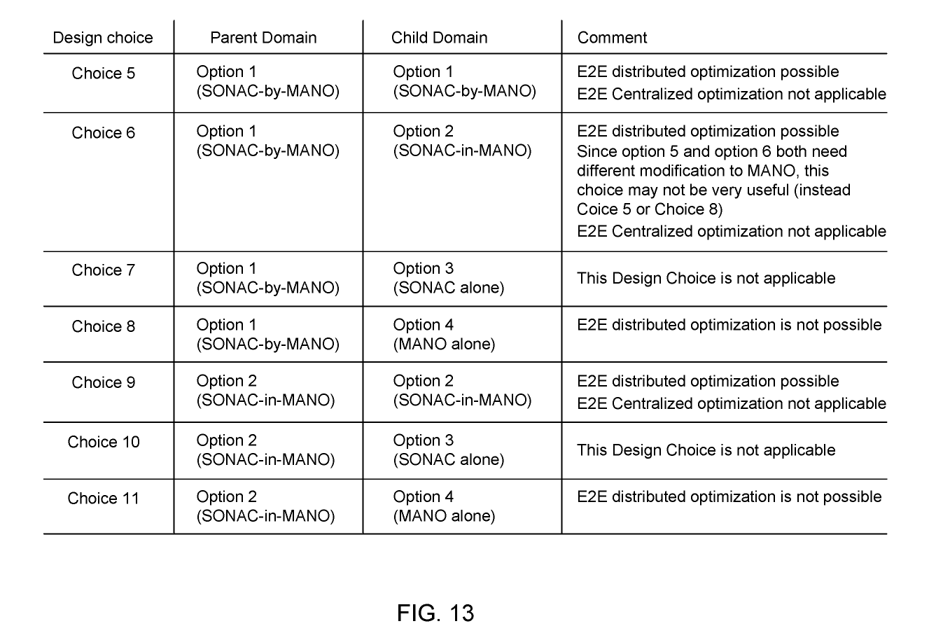

FIG. 13 is a chart illustrating example combinations of the example interworking options of FIGS. 4-7 usable in the hierarchical network management scheme of FIG. 12. As may be seen, the chart of FIG. 13 extends the chart of FIG. 8, by utilizing different interworking options implemented in the Parent Domain NM 308.

As may be seen in FIG. 13, E2E distributed optimization of network management is possible for combinations: Choice 5, Choice 6 and Choice 9, while centralized optimization of network management is possible for combinations Choice 8 and Choice 11. On the other hand, if the Child Domain NM 306 is provisioned with an exposure function, such that functions and locations in the Child Domain 304 are visible to the Parent Domain NM 308, then distributed optimization may be possible for combinations Choice 8 and Choice 11.

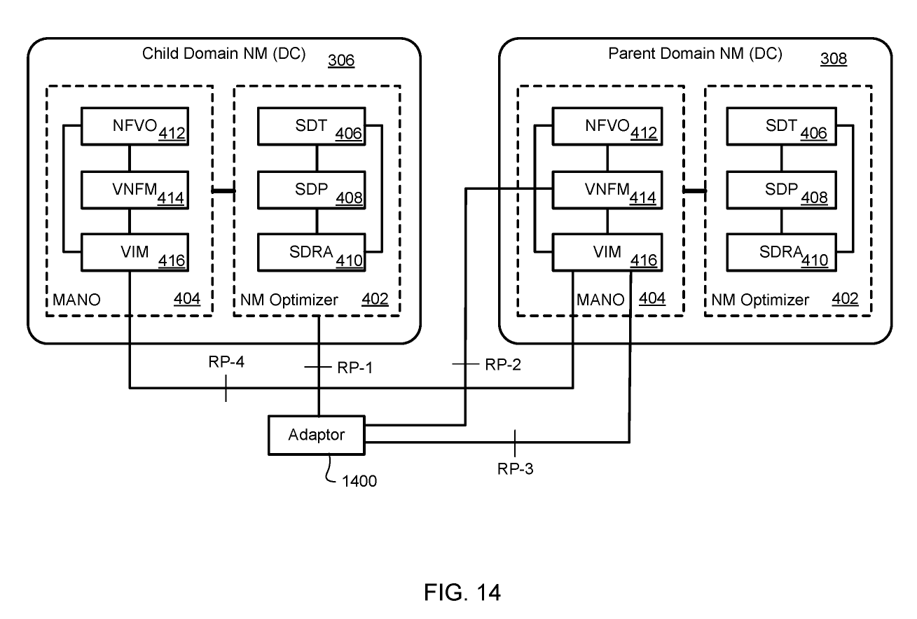

FIG. 14 is a block diagram schematically illustrating a fourth example interworking between parent and child domains in accordance with representative embodiments of the present invention. The arrangement of FIG. 14 illustrates example interworking combination Choice 5 from the chart of FIG. 13. With this arrangement, the Child Domain 304 may be represented to the Parent Domain NM 308 as an NFV-capable virtual node or virtual server. In this case, the Child Domain NM 306 may provide an abstraction of the Child Domain 304 to the Parent Domain NM 308, for example via RP-4, which can then provide centralized network management optimization. An Adaptor function 1400 may be instantiated (either in the Parent Domain NM 308 or the Child Domain NM 306) to adapt instructions (such as, for example virtual network function management messages) from the Parent Domain MANO 404 into service request messages supplied to the Child Domain SONAC 402 which operates as a Network Management Optimizer for the Child Domain 304. It will be appreciated that example interworking combinations Choice 6 and Choice 9 from the chart of FIG. 13 are closely similar.

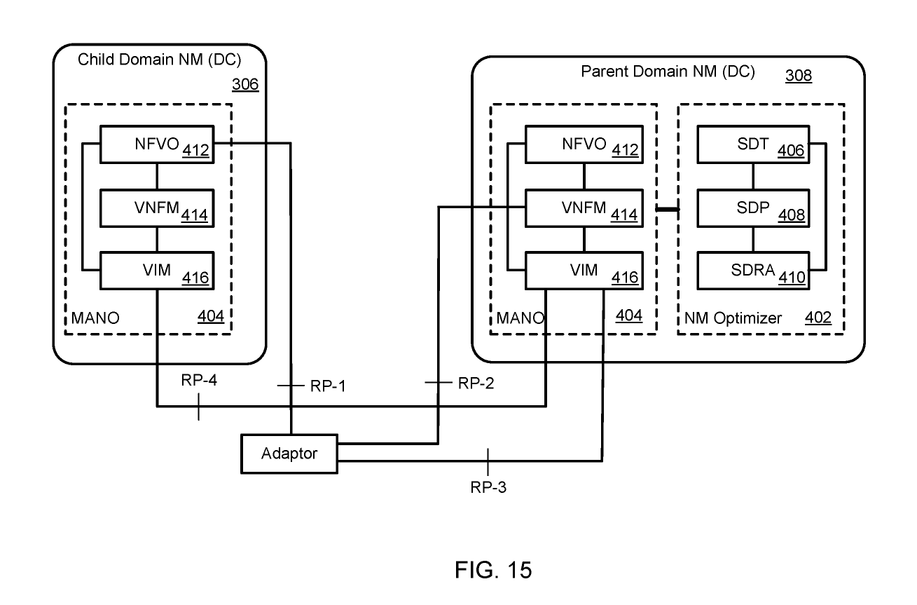

FIG. 15 is a block diagram schematically illustrating a fifth example interworking between parent and child domains in accordance with representative embodiments of the present invention. The arrangement of FIG. 15 illustrates example interworking combination Choice 8 from the chart of FIG. 13. With this arrangement, the Child Domain 304 may be represented to the Parent Domain NM 308 as an NFV-capable virtual node or virtual server. In this case, the Child Domain NM 306 may provide an abstraction of the Child Domain 304 to the Parent Domain NM 308, for example via RP-4, which can then provide centralized network management optimization. An Adaptor function 1500 may be instantiated (either in the Parent Domain NM 308 or the Child Domain NM 306) to adapt instructions (such as, for example virtual network function management messages) from the Parent Domain MANO 404 into service request messages supplied to the Child Domain NFVO 402. It will be appreciated that example interworking combinations Choice 11 from the chart of FIG. 13 is closely similar.

In the embodiments of FIGS. 14 and 15, the Adaptor function 1400, 1500 may operate to adapt instructions from the Parent Domain MANO 404 into service request messages supplied to the Child Domain SONAC 402 or MANO 404. More generally, the Adaptor function 1400, 1500 may operate bi-directionally, if desired, adapting messages between the parent and child network management systems. Adaptation between Parent Domain MANO 404 instructions (such as, for example virtual network function management messages) and service request messages for the Child Domain NM 306 is just one example. In some cases, the adaptation function may operate to adapt messages without altering the type of message. For example, the parent and child domain network management systems may use respective different identifiers to identify a given resource or network service. In such cases, the adaptation function may operate to replace the identifiers in messages received from the parent domain network management system (for example) with the corresponding identifiers used by the child domain network management system.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by an establishing unit/module for establishing a serving cluster, an instantiating unit/module, an establishing unit/module for establishing a session link, an maintaining unit/module, other performing unit/module for performing the step of the above step. The respective units/modules may be hardware, software, or a combination thereof. For instance, one or more of the units/modules may be an integrated circuit, such as field programmable gate arrays (FPGAs) or application-specific integrated circuits (ASICs).

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for managing a communications network, the method comprising:
providing a parent network manager in a parent domain of the communications network, the parent network manager comprising at least one of a parent Service Oriented Network Auto Creation (SONAC) function and a parent MANagement and Orchestration (MANO) function; and
providing a child network manager in a child domain of the communications network, the child network manager comprising at least one of a child Service Oriented Network Auto Creation (SONAC) function and a child MANagement and Orchestration (MANO) function;
wherein at least one of the parent network manager and the child network manager comprises the Service Oriented Network Auto Creation (SONAC) function,
the parent and child network managers cooperating to optimize management of the parent and child domains of the communications network.

2. The method as claimed in claim 1, wherein the child network manager represents the child domain to the parent network manager as a Network Function Virtualization Capable virtual node of the communications network.

3. The method as claimed in claim 1, wherein the child network manager is responsive to either one or both of network service request messages and virtual network function management messages from the parent network manager to implement network management decisions of the parent network manager within the child domain.

4. The method as claimed in claim 3, wherein an adaptation function is configured to adapt messages from the parent network manager and forward corresponding adapted messages to the child network manager.

5. The method as claimed in claim 4, wherein the adaptation function comprises replacing one or more identifiers in messages from the parent network manager with corresponding identifiers known by the child domain network manager.

6. A network management entity of a communications network, the network management entity comprising:
a Service Oriented Network Auto Creation (SONAC) function including:
a Software Defined Topology (SDT) controller configured to define a logical network topology;
a Software Defined Protocol (SDP) controller configured to define a logical end-to-end protocol; and
a Software Defined Resource Allocation (SDRA) controller configured to define an allocation of network resources for logical connection in the logical network topology; and
a MANagement and Orchestration (MANO) function including a Network Function Virtualization Orchestrator (NFVO) configured to receive topology information from the Software Defined Topology (SDT) controller of the SONAC function.

7. The network management entity as claimed in claim 6, wherein the MANO function further comprises a Virtual Network Function Manager (VNFM) configured to receive protocol information from the SDP controller of the SONAC function.

8. The network management entity as claimed in claim 6, wherein the MANO function further comprises a Virtual Infrastructure Manager (VIM) configured to receive resource allocation data from the SDRA controller of the SONAC.
a Virtual Network Function Manager (VNFM); and
a Virtualized Infrastructure Manager

9. A network management entity of a communications network, the network management entity comprising:
a Service Oriented Network Auto Creation (SONAC) function including:
a Software Defined Topology (SDT) controller configured to define a logical network topology;
a Software Defined Protocol (SDP) controller configured to define a logical end-to-end protocol; and
a Software Defined Resource Allocation (SDRA) controller configured to define an allocation of network resources for logical connection in the logical network topology;
wherein the SONAC is configured to implement functionality of a Network Function Virtualization Orchestrator NFVO function of a conventional MANO.
